(19) United States
(12) Patent Application Publication
(10) Pub. No.: US 2023/0051704 A1
(43) Pub. Date: Feb. 16, 2023

(54) OBJECT DEFORMATIONS

(71) Applicant: Hewlett-Packard Development Company, L.P., Spring, TX (US)

(72) Inventors: He Luan, Palo Alto, CA (US); Juan Carlos Catana Salazar, San Diego, CA (US); Jun Zeng, Palo Alto, CA (US)

(73) Assignee: Hewlett-Packard Development Company, L.P., Spring, TX (US)

(21) Appl. No.: 17/792,680

(22) PCT Filed: Jan. 31, 2020
(86) PCT No.: PCT/US2020/016097

§ 371 Date: Jul. 13, 2022

(51) Int. Cl. B29C 64/386

(52) U.S. Cl. CPC B29C 64/386; B33Y 50/02

(57) ABSTRACT

Examples of methods for predicting object deformations are described herein. In some examples, a method includes predicting a point cloud. In some examples, the predicted point cloud indicates a predicted object deformation. In some examples, the point cloud may be predicted using a machine learning model and edges determined from an input point cloud.

### BACKGROUND

Three-dimensional (3D) solid parts may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final part. In some additive manufacturing techniques, the build material may be cured or fused.

### BRIEF DESCRIPTION OF THE DRAWINGS

FIG. 1 is a flow diagram illustrating an example of a method for predicting object deformation;

FIG. 2 is a flow diagram illustrating another example of a method for predicting object deformation;

FIG. 3 is a block diagram of an example of an apparatus that may be used in predicting object deformation;

FIG. 4 is a block diagram illustrating an example of a computer-readable medium for predicting object deformation;

FIG. 5 is a block diagram illustrating an example of a machine learning model architecture;

FIG. 6A is a diagram illustrating an example of a point cloud of a 3D object model; and

FIG. 6B is a diagram illustrating an example of a predicted point cloud.

### DETAILED DESCRIPTION

Additive manufacturing may be used to manufacture three-dimensional (3D) objects. 3D printing is an example of additive manufacturing. For example, thermal energy may be projected over material in a build area, where a phase change and solidification in the material may occur at certain voxels. A voxel is a representation of a location in a 3D space (e.g., a component of a 3D space). For instance, a voxel may represent a volume that is a subset of the 3D space. In some examples, voxels may be arranged on a 3D grid. For instance, a voxel may be cuboid or rectangular prismatic in shape. In some examples, voxels in the 3D space may be uniformly sized or non-uniformly sized. Examples of a voxel size dimension may include 25.4 millimeters (mm)/150≈170 microns for 150 dots per inch (dpi), 490 microns for 50 dpi, 2 mm, 4 mm, etc. The term “voxel level” and variations thereof may refer to a resolution, scale, or density corresponding to voxel size.

In some examples, the techniques described herein may be utilized for various examples of additive manufacturing. For instance, some examples may be utilized for plastics, polymers, semi-crystalline materials, metals, etc. Some additive manufacturing techniques may be powder-based and driven by powder fusion. Some examples of the approaches described herein may be applied to area-based powder bed fusion-based additive manufacturing, such as Stereolithography (SLA), Multi-Jet Fusion (MJF), Metal Jet Fusion, metal binding printing, Selective Laser Melting (SLM), Selective Laser Sintering (SLS), liquid resin-based printing, etc. Some examples of the approaches described herein may be applied to additive manufacturing where agents carried by droplets are utilized for voxel-level thermal modulation.

In some examples of additive manufacturing, thermal energy may be utilized to fuse material (e.g., particles, powder, etc.) to form an object. For example, agents (e.g., fusing agent, detailing agent, etc.) may be selectively deposited to control voxel-level energy deposition, which may trigger a phase change and/or solidification for selected voxels. The manufactured object geometry may be driven by the fusion process, which enables predicting or inferring the geometry following manufacturing. Some first-principle-based manufacturing simulation approaches are relatively slow, complicated, and/or may not provide target resolution (e.g., sub-millimeter resolution). Some machine learning approaches (e.g., some deep learning approaches) may offer improved resolution and/or speed.

A machine learning model is a structure that learns based on training. Examples of machine learning models may include artificial neural networks (e.g., deep neural networks, convolutional neural networks (CNNs), dynamic graph CNNs (DGCNNs), etc.). Training the machine learning model may include adjusting a weight or weights of the machine learning model. For example, a neural network may include a set of nodes, layers, and/or connections between nodes. The nodes, layers, and/or connections may have associated weights. The weights may be adjusted to train the neural network to perform a function, such as predicting object geometry after manufacturing or object deformation. Examples of the weights may be in a relatively large range of numbers, and may be negative or positive.

Some examples of the techniques described herein may utilize a machine learning model (e.g., a deep neural network) to predict object geometry of an object after manufacturing and/or to predict object deformation from a 3D object model (e.g., computer-aided design (CAD) model). For example, a machine learning model may provide a quantitative model for directly predicting object deformation. Object deformation is a change or disparity in object geometry from a target geometry (e.g., 3D object model geometry). Object deformation may occur during manufacturing due to thermal diffusion, thermal change, gravity, manufacturing errors, etc.

In some examples of the techniques described herein, point clouds may be utilized to represent 3D objects and/or 3D object geometry. A point cloud is a set of points or locations in a 3D space. A point cloud may be utilized to represent a 3D object or 3D object model. For example, a 3D object may be scanned with a 3D scanner (e.g., depth sensor(s), camera(s), LIDAR sensors, etc.) to produce a point cloud representing the 3D object (e.g., manufactured object, 3D printed object, etc.). The point cloud may include a set of points representing locations on the surface of the 3D object in 3D space. In some examples, a point cloud may be generated from a 3D object model (e.g., CAD model). For example, a random selection of the points from a 3D object model may be performed. For instance, a point cloud may be generated from a uniform random sampling of points from a surface of a 3D object model in some approaches. In some examples, a point cloud may be generated by uniformly projecting points over the surface of 3D object model mesh. For example, a uniform density of points over the whole surface or a constant number of points per triangle in the mesh may be generated in some approaches. A uniform projection may refer to selecting points (e.g., point pairs) within a threshold distance from each other. A point cloud may be an irregular structure, where points may not necessarily correspond to a uniform grid.

Point clouds may provide a flexible geometric representation. However, applying deep learning to point cloud data may not be straightforward. For example, some deep neural network models may utilize input data with regular structure, while point clouds may have irregular structure. In some approaches, point clouds may be converted to a 3D volumetric representation for use with neural network models. However, converting the point clouds to a 3D volumetric representation may produce quantization artifacts and highly sparse data, which may fail to capture fine-gained features. Accordingly, approaches that can represent and learn local geometrical structures from unstructured point clouds may be beneficial.

In some examples of the techniques described herein, a machine learning model may be utilized to predict a point cloud representing a manufactured object (before the object is manufactured, for instance). The machine learning model may predict the point cloud of the object (e.g., object deformation) based on an input point cloud of a 3D object model (e.g., CAD model). In some examples, each point of the input point cloud may be utilized and/or deformation prediction may be performed for all points of the input point cloud.

In some examples, a machine learning model may be trained using point clouds of 3D object models (e.g., computer-aided design (CAD) models) and point clouds from scans of corresponding 3D objects after manufacturing. For instance, a 3D object model or models may be utilized to manufacture (e.g., print) a 3D object or objects. An input point cloud or clouds may be determined from the 3D object model(s). A point cloud or point clouds may be obtained by scanning the manufactured 3D object or objects. In some examples, a ground truth for training the machine learning model may include the point cloud(s) after alignment to the input point clouds. In some examples, a ground truth for training the machine learning model may include a deformation point cloud or deformation point clouds, which may be calculated as a difference between 3D scanned point cloud(s) and 3D object model(s) point cloud(s). In some examples, a machine learning model may be trained with first point clouds from 3D object models and second point clouds from scanned objects.

Throughout the drawings, identical or similar reference numbers may designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

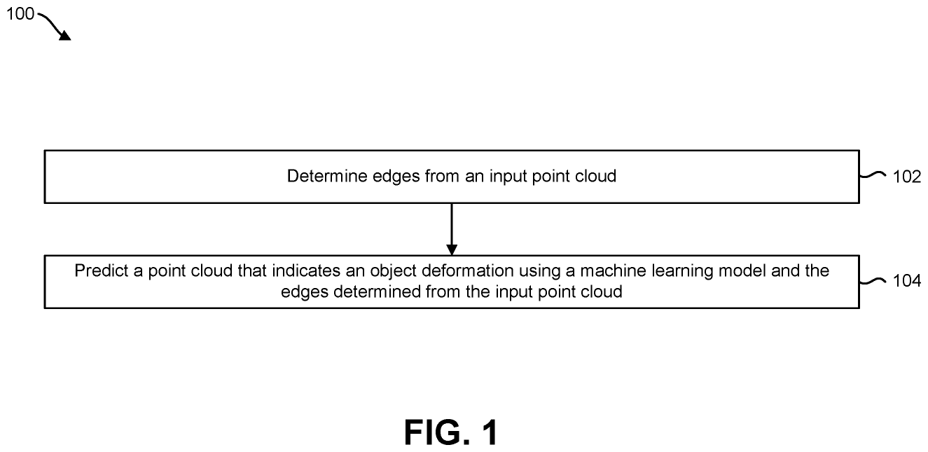

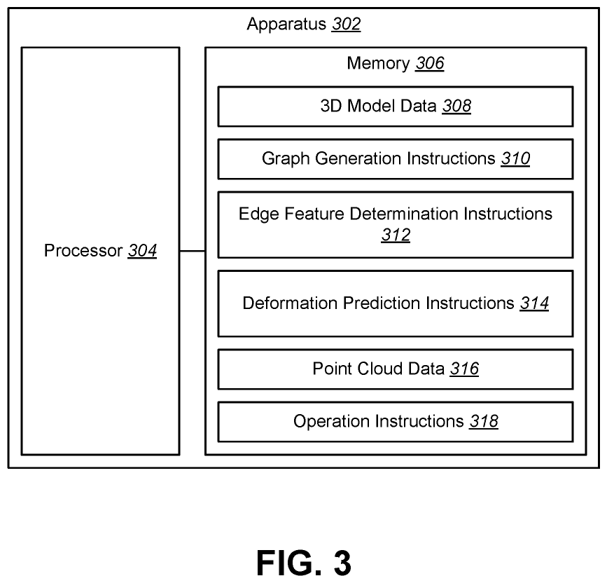

FIG. 1 is a flow diagram illustrating an example of a method 100 for predicting object deformation. The method 100 and/or an element or elements of the method 100 may be performed by an apparatus (e.g., electronic device). For example, the method 100 may be performed by the apparatus 302 described in connection with FIG. 3.

The apparatus may determine 102 edges from an input point cloud. An edge is a line or association between points. In some examples, the apparatus may determine 102 edges from the input point cloud by determining neighbor points for each point of the input point cloud. A neighbor point is a point that meets a criterion relative to another point. For example, a point or points that are nearest to another point (in terms of Euclidean distance, for example) may be a neighbor point or neighbor points relative to the other point. In some examples, the edges may be determined 102 as lines or associations between a point and corresponding neighbor points.

In some examples, the apparatus may determine the nearest neighbors using a K nearest neighbors (KNN) approach. For example, K may be a value that indicates a threshold number of neighbor points. For instance, the apparatus may determine the K points that are nearest to another point as the K nearest neighbors.

The apparatus may generate edges between a point and the corresponding neighbor points. For instance, the apparatus may store a record of each edge between a point and the corresponding neighbor points.

The apparatus may predict 104 a point cloud that indicates an object deformation using a machine learning model and the edges determined from the input point cloud. For example, the apparatus may determine an edge feature for each of the edges determined from the input point cloud. An edge feature is a value (or vector of values) that indicates a relationship between points (e.g., neighbor points). In some examples, an edge feature may represent a geometrical structure associated with an edge connecting two points (e.g., neighbor points). The apparatus may utilize the machine learning model and the edge features to predict 104 the point cloud. For instance, the machine learning model may convolve the edge features to produce the predicted point cloud. In some examples, the machine learning model (e.g., deep learning model) may be a deformation predictor. To build the machine learning model, point clouds of a 3D object model(s) may be utilized as input to predict the point clouds of a manufactured object, where point clouds of scanned objects may be utilized as ground truth.

The predicted point cloud may indicate shape (e.g., geometry) of an object. The predicted point cloud may indicate an object deformation (e.g., predicted object deformation). For instance, a change or disparity (e.g., difference) between the predicted point cloud and the input point cloud may indicate a portion or portions of the object that are predicted to deform during manufacturing. In some examples, the predicted object deformation is based on thermal change (e.g., complicated thermal change, thermal diffusion, etc.) in 3D printing. In some examples, the 3D object model (e.g., CAD design) and the shape (e.g., geometry) prediction may be expressed as (x, y, z) object surface coordinates represented as point clouds.

In some examples, the apparatus may provide the predicted point cloud. For instance, the apparatus may store the predicted point cloud, may send the predicted point cloud to another device, and/or may present the predicted point cloud (on a display and/or in a user interface, for example). In some examples, the apparatus may utilize the predicted point cloud to compensate for the predicted deformations. For instance, the apparatus may adjust the 3D object model (e.g., CAD model) and/or printing variables (e.g., amount of agent, thermal exposure time, etc.) to reduce or avoid the predicted deformation. In some approaches, the apparatus may perform iterative compensation. For instance, the apparatus may predict object deformation using a 3D object model, may adjust the 3D object model (e.g., the placement of a fusing voxel or voxels), and may repeat predicting object deformation using the adjusted 3D model. Adjustments that reduce predicted object deformation may be retained and/or amplified. Adjustments that increase predicted object deformation may be reversed and/or reduced. This procedure may iterate until the predicted deformation is reduced to a target amount. In some examples, a 3D printer may print the adjusted (e.g., deformation-reduced and/or improved) 3D model.

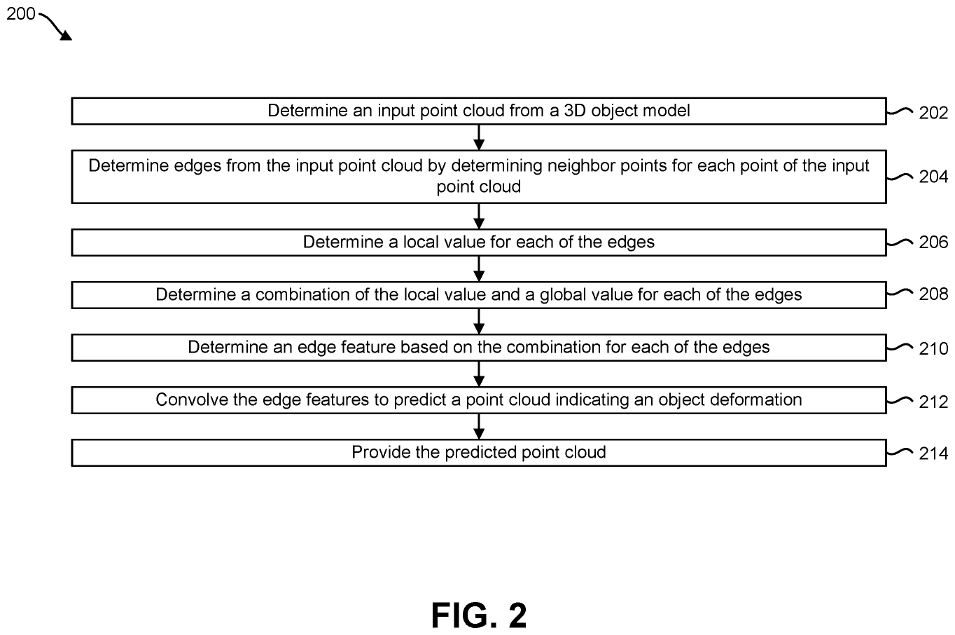

FIG. 2 is a flow diagram illustrating another example of a method 200 for predicting object deformation. The method 200 and/or an element or elements of the method 200 may be performed by an apparatus (e.g., electronic device). For example, the method 200 may be performed by the apparatus 302 described in connection with FIG. 3.

The apparatus may determine 202 an input point cloud from a 3D object model. In some examples, determining 202 the input point cloud may be performed as described above. For instance, the apparatus may uniformly randomly sample surface points from the 3D object model in some approaches.

A 3D object model is a 3D geometrical model of an object. Examples of 3D object models include CAD models, mesh models, 3D surfaces, etc. In some examples, a 3D object model may be utilized to manufacture (e.g., print) an object. In some examples, the apparatus may receive a 3D object model from another device (e.g., linked device, networked device, removable storage, etc.) or may generate the 3D object model.

The apparatus may determine 204 edges from the input point cloud by determining neighbor points for each point of the input point cloud. In some examples, determining 204 the edges may be performed as described in relation to FIG. 1. In some approaches, a point (of a point cloud, for instance) may be denoted xᵢ=(xᵢ, yᵢ, zᵢ), where xᵢ is a location of the point in an x dimension or width dimension, yᵢ is a location of the point in a y dimension or depth dimension, zᵢ is a location of the point in a z dimension or height dimension, and i is an index for a point cloud. For instance, for each point xᵢ, the apparatus may find neighbor points (e.g., KNN). The apparatus may generate edges between each point and corresponding neighbor points. In some examples, determining 204 the edges may generate a graph G=(V, E), where V are the points (or vertices) and E are the edges of the graph G. A graph is a data structure including a vertex or vertices and/or an edge or edges. An edge may connect two vertices. In some examples, a graph may not be a visual display or plot of data. A plot or visualization of a graph may be utilized to illustrate and/or present a graph.

In some examples, determining 204 the edges may be based on distance metrics. For instance, the apparatus may determine a distance metric between a point and a candidate point. A candidate point is a point in the point cloud that may potentially be selected as a neighbor point. In some examples, the neighbor points (e.g., KNN) may be determined in accordance with a Euclidean distance as provided in Equation (1).

d(xᵢ,xⱼ)=\sqrt{(xᵢ,xⱼ)²+(yᵢ,yⱼ)²+(zᵢ,zⱼ)²} (1)

In Equation (1), j is an index for points where j≠i. The K candidate points that are nearest to the point may be selected as the neighbor points and/or edges may be generated between the point and the K nearest candidate points. K may be predetermined or determined based on a user input.

The apparatus may determine 206 a local value for each of the edges. A local value is a value (or vector of values) that indicates local neighborhood information to simulate a thermal diffusion effect. In some examples, the local value may be determined as (xⱼ−xᵢ). For instance, the local value may be a difference between the point and a neighbor point. In some examples, the local value may be weighted with a local weight θₘ (e.g., θₘ·(xⱼ−xᵢ)). In some examples, the local weight may be estimated during machine learning model training for learning local features and/or representations. For instance, θₘ·(xⱼ−xᵢ) may capture local neighborhood information, with a physical insight to simulate more detailed thermal diffusive effects. Examples of the local weight may be in a relatively large range of numbers, and may be negative or positive.

The apparatus may determine 208 a combination of the local value and a global value for each of the edges. A global value is a value that indicates global information to simulate a global thermal mass effect. For instance, the global value may be the point xᵢ. In some examples, the global value may be weighted with a global weight ϕₘ (e.g., ϕₘ·xᵢ). In some examples, the global weight may be estimated during machine learning model training for learning a global deformation effect on each point. For instance, ϕₘ·xᵢ may explicitly adopt global shape structure, with a physical insight to simulate the overall thermal mass. In some examples, determining 208 the combination of the local value and the global value for each of the edges may include summing the local value and the global value (with or without weights) for each of the edges. For instance, the apparatus may calculate θₘ·(xⱼ−xᵢ)+ϕₘ·xᵢ. Examples of the global weight may be in a relatively large range of numbers, and may be negative or positive.

The apparatus may determine 210 an edge feature based on the combination for each of the edges. In some examples, the apparatus may determine 210 the edge feature by applying an activation function to the combination for each of the edges. For instance, the apparatus may determine 210 the edge feature in accordance with Equation (2).

eᵢⱼₘ=ReLU(θₘ·(xⱼ−xᵢ)+ϕₘ·xᵢ) (2)

In Equation (2), eᵢⱼₘ is the edge feature, m is a channel index for a machine learning model (e.g., convolutional neural network), and ReLU is a rectified linear unit activation function. For instance, the rectified linear unit activation function may take a maximum of 0 and the input value. Accordingly, the rectified linear unit activation function may output zeros for negative input values and may output values equal to positive input values.

The apparatus may convolve 212 the edge features to predict a point cloud indicating an object deformation. In some examples, the apparatus may convolve 212 the edge features by summing edge features. For instance, the apparatus may convolve 212 the edge features in accordance with Equation (3).

x′ᵢₘ=Σ_{j:(i,j∈E)}eᵢⱼₘ (3)

In Equation (3), x′ᵢₘ is a point of the predicted point cloud (e.g., an i-th vertex). As illustrated by Equation (3), convolution on the graph (e.g., KNN graph) is transferred to a regular convolution. Accordingly, some of the techniques described herein enable a machine learning model (e.g., convolutional neural network) to predict object deformation (e.g., point-cloud-wise object deformation) using input point clouds.

The apparatus may provide 214 the predicted point cloud. In some examples, providing 214 the predicted point cloud may be performed as described in relation to FIG. 1. For instance, the apparatus may store the predicted point cloud, may send the predicted point cloud to another device, and/or may present the predicted point cloud (on a display and/or in a user interface, for example). For instance, the apparatus may present (on a display and/or user interface, for example) the predicted point cloud superimposed on the 3D model and/or may indicate a point or points (e.g., portions) of predicted object deformation. In some examples, the apparatus may compensate for the predicted object deformation indicated by the predicted point cloud. In some examples, operation(s), function(s), and/or element(s) of the method 200 may be omitted and/or combined.

From a physical domain perspective, some additive manufacturing techniques (e.g., MJF) are fusion processes, where the thermal diffusion may dominate the end-part deformation. With edge convolution, convolution may be enabled on point clouds. In some examples, a machine learning model (e.g., DGCNN) may include a stack of edge convolution blocks and/or layers. For instance, the machine learning model may include edge convolution layers. The machine learning model may extract the geometrically deformed features and/or may provide accurate object geometry prediction.

FIG. 3 is a block diagram of an example of an apparatus 302 that may be used in predicting object deformation. The apparatus 302 may be a computing device, such as a personal computer, a server computer, a printer, a 3D printer, a smartphone, a tablet computer, etc. The apparatus 302 may include and/or may be coupled to a processor 304, and/or a memory 306. The processor 304 may be in electronic communication with the memory 306. In some examples, the apparatus 302 may be in communication with (e.g., coupled to, have a communication link with) an additive manufacturing device (e.g., a 3D printing device). In some examples, the apparatus 302 may be an example of a 3D printing device. The apparatus 302 may include additional components (not shown) and/or some of the components described herein may be removed and/or modified without departing from the scope of this disclosure.

The processor 304 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 306. The processor 304 may fetch, decode, and/or execute instructions (e.g., deformation prediction instructions 314) stored in the memory 306. In some examples, the processor 304 may include an electronic circuit or circuits that include electronic components for performing a functionality or functionalities of the instructions (e.g., deformation prediction instructions 314). In some examples, the processor 304 may perform one, some, or all of the functions, operations, elements, methods, etc., described in connection with one, some, or all of FIGS. 1-6B.

The memory 306 may be any electronic, magnetic, optical, or other physical storage device that contains or stores electronic information (e.g., instructions and/or data). Thus, the memory 306 may be, for example, Random Access Memory (RAM), Electrically Erasable Programmable Read-Only Memory (EEPROM), a storage device, an optical disc, and the like. In some implementations, the memory 306 may be a non-transitory tangible machine-readable storage medium, where the term “non-transitory” does not encompass transitory propagating signals.

In some examples, the apparatus 302 may also include a data store (not shown) on which the processor 304 may store information. The data store may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the memory 306 may be included in the data store. In some examples, the memory 306 may be separate from the data store. In some approaches, the data store may store similar instructions and/or data as that stored by the memory 306. For example, the data store may be non-volatile memory and the memory 306 may be volatile memory.

In some examples, the apparatus 302 may include an input/output interface (not shown) through which the processor 304 may communicate with an external device or devices (not shown), for instance, to receive and store the information pertaining to the objects for which deformation may be predicted. The input/output interface may include hardware and/or machine-readable instructions to enable the processor 304 to communicate with the external device or devices. The input/output interface may enable a wired or wireless connection to the external device or devices. In some examples, the input/output interface may further include a network interface card and/or may also include hardware and/or machine-readable instructions to enable the processor 304 to communicate with various input and/or output devices, such as a keyboard, a mouse, a display, another apparatus, electronic device, computing device, etc., through which a user may input instructions into the apparatus 302. In some examples, the apparatus 302 may receive 3D model data 308 and/or point cloud data 316 from an external device or devices (e.g., 3D scanner, removable storage, network device, etc.).

In some examples, the memory 306 may store 3D model data 308. The 3D model data 308 may be generated by the apparatus 302 and/or received from another device. Some examples of 3D model data 308 include a 3 MF file or files, a 3D computer-aided design (CAD) image, object shape data, mesh data, geometry data, etc. The 3D model data 308 may indicate the shape of an object or objects.

In some examples, the memory 306 may store point cloud data 316. The point cloud data 316 may be generated by the apparatus 302 and/or received from another device. Some examples of point cloud data 316 include a point cloud or point clouds generated from the 3D model data 308, a point cloud or point clouds from a scanned object or objects, and/or a predicted point cloud or point clouds. For example, the processor 304 may determine an input point cloud from a 3D object model indicated by the 3D model data 308. The input point cloud may be stored with the point cloud data 316. In some examples, the apparatus may receive a 3D scan or scans of an object or objects from another device (e.g., linked device, networked device, removable storage, etc.) or may capture the 3D scan.

The memory 306 may store graph generation instructions 310. The processor 304 may execute the graph generation instructions 310 to generate a graph. For instance, the processor 304 may execute the graph generation instructions 310 to generate a graph by determining edges for each point of an input point cloud. In some examples, the processor 304 may determine the input point cloud from the 3D model data 308. In some examples, determining the edges for each point of the input point cloud may be performed as described in relation to FIG. 1 and/or FIG. 2. In some examples, the graph may include points of the input point cloud as vertices and the determined edges.

The memory 306 may store edge feature determination instructions 312. In some examples, the processor 304 may execute the edge feature determination instructions 312 to determine an edge feature for each of the edges of the graph. In some examples, this may be accomplished as described in connection with FIG. 2. For instance, the processor 304 may determine a local value for each of the edges, may determine a combination of the local value and a global value for each of the edges, and/or may apply an activation function to each of the combinations to determine the edge feature.

The memory 306 may store deformation prediction instructions 314. In some examples, the processor 304 may execute the deformation prediction instructions 314 to predict, based on the edge features, an object deformation resulting from 3D printing of an object model, where the predicted object deformation is indicated by a point cloud. In some examples, predicting the deformation may be accomplished as described in connection with FIG. 1 and/or FIG. 2. In some cases, the deformation prediction may be performed before any 3D printing of the object, if at all. In some examples, the processor 304 may predict the object deformation using a machine learning model that comprises layers to convolve the edge features.

In some examples, the processor 304 may execute the operation instructions 318 to perform an operation based on the predicted point cloud and/or the predicted object deformation. For example, the processor 304 may present the predicted point cloud and/or the predicted object deformation on a display, may store the predicted point cloud and/or the predicted object deformation in the memory 306, and/or may send the predicted point cloud and/or the predicted object deformation to another device or devices. In some examples, the processor 304 may compensate for the predicted point cloud and/or predicted object deformation. For instance, the processor 304 may adjust the 3D model data 308 and/or printing instructions to compensate for the predicted deformation in order to reduce actual deformation when the object is printed. For instance, the processor 304 may drive model setting based on a deformation-compensated 3D model that is based on the predicted point cloud and/or the predicted object deformation.

In some examples, the processor 304 may train a machine learning model. For example, the processor 304 may train the machine learning model using point cloud data 316 from a 3D object model and point cloud data 316 from a corresponding scanned object that was manufactured from the 3D object model.

Some machine learning approaches may utilize training data to predict or infer manufactured object deformation. The training data may indicate deformation that has occurred during a manufacturing process. For example, object deformation may be assessed based on a 3D object model (e.g., computer aided drafting (CAD) model) and a 3D scan of an object that has been manufactured based on the 3D object model. The object deformation assessment (e.g., the 3D object model and the 3D scan) may be utilized as a ground truth for machine learning. For instance, the object deformation assessment may enable deformation prediction and/or compensation. In order to assess object deformation, the 3D object model and the 3D scan may be registered. Registration is a procedure to align objects.

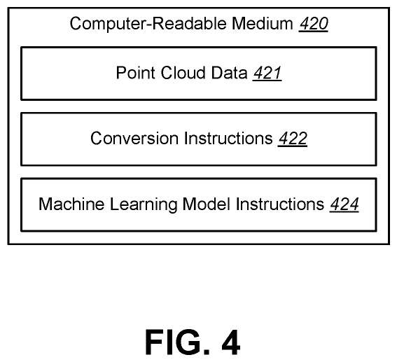

FIG. 4 is a block diagram illustrating an example of a computer-readable medium 420 for predicting object deformation. The computer-readable medium 420 may be a non-transitory, tangible computer-readable medium 420. The computer-readable medium 420 may be, for example, RAM, EEPROM, a storage device, an optical disc, and the like. In some examples, the computer-readable medium 420 may be volatile and/or non-volatile memory, such as DRAM, EEPROM, MRAM, PCRAM, memristor, flash memory, and the like. In some implementations, the memory 306 described in connection with FIG. 3 may be an example of the computer-readable medium 420 described in connection with FIG. 4.

The computer-readable medium 420 may include code (e.g., data and/or instructions). For example, the computer-readable medium 420 may include point cloud data 421, conversion instructions 422, and/or machine learning model instructions 424.

In some examples, the computer-readable medium 420 may store point cloud data 421. Some examples of point cloud data 421 include samples of a 3D object model (e.g., 3D CAD file), predicted point cloud(s), and/or scan data, etc. The point cloud data 421 may indicate the shape of a 3D object (e.g., an actual 3D object or a 3D object model).

In some examples, the conversion instructions 422 are code to cause a processor to convert an input point cloud into a graph based on determining neighbor points for each point of the input cloud. In some examples, this may be accomplished as described in connection with FIG. 1, FIG. 2, and/or FIG. 3. For instance, the conversion instructions 422 may be executed to determine neighbor points and edges for each point of the input point cloud. Determining the neighbor points may include determining a set of nearest neighbor points relative to a point of the input point cloud. The input point cloud may correspond to a 3D object model for 3D printing. In some examples, the conversion may be accomplished using a KNN approach.

In some examples, the machine learning model instructions 424 are code to cause the processor to use a machine learning model to predict, based on the graph, 3D printing object deformation as a point cloud. In some examples, this may be accomplished as described in relation to FIG. 1, FIG. 2, and/or FIG. 3. For instance, the machine learning model instructions 424 may be executed to determine an edge feature for each edge of the graph and/or to convolve the edge features by the machine learning model to predict the 3D printing object deformation as a point cloud.

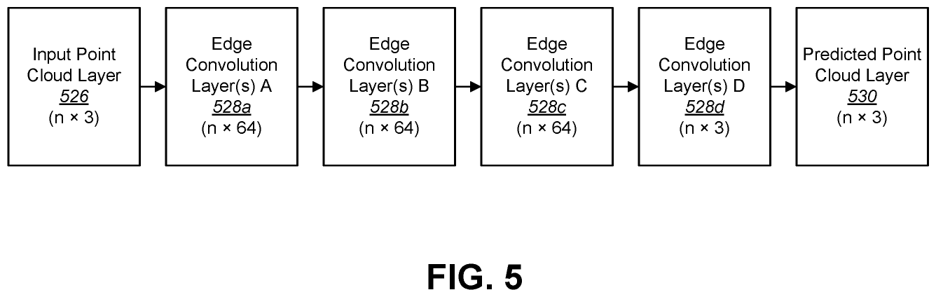

FIG. 5 is a block diagram illustrating an example of a machine learning model architecture. The machine learning model architecture may be an example of the machine learning models described herein. The machine learning model architecture includes nodes and layers. For example, the machine learning model architecture includes an input point cloud layer 526, edge convolution layer(s) A 528a, edge convolution layer(s) B 528b, edge convolution layer(s) C 528c, edge convolution layer(s) D 528d, and a predicted point cloud layer 530.

In the example of FIG. 5, the machine learning model architecture stacks several edge convolution layers 528a-d. While FIG. 5 illustrates one example of a machine learning architecture that may be utilized in accordance with some of the techniques described herein, the architecture is flexible and/or other architectures may be utilized. The input point cloud layer 526 may have dimensions of n×3, where n represents n points of the point cloud (from the 3D object model, for instance) and 3 represents x, y, and z coordinates. In another example, the machine learning model architecture may have more features as input (e.g., the geometric normal of the x, y, and z coordinates, where the input layer would have dimensions of n×6). In the example of FIG. 5, edge convolution layer(s) A 528a, edge convolution layer(s) B 528b, and edge convolution layer(s) C 528c each have dimensions of n×24. Edge convolution layer(s) D 528d has dimensions of n×3. The predicted point cloud layer 530 has dimensions of n×3. In some examples, more or fewer edge convolution blocks may be utilized, which may include more or fewer edge convolution layers in each block. Besides edge convolution blocks, other layers (e.g., pooling layers) may or may not be added.

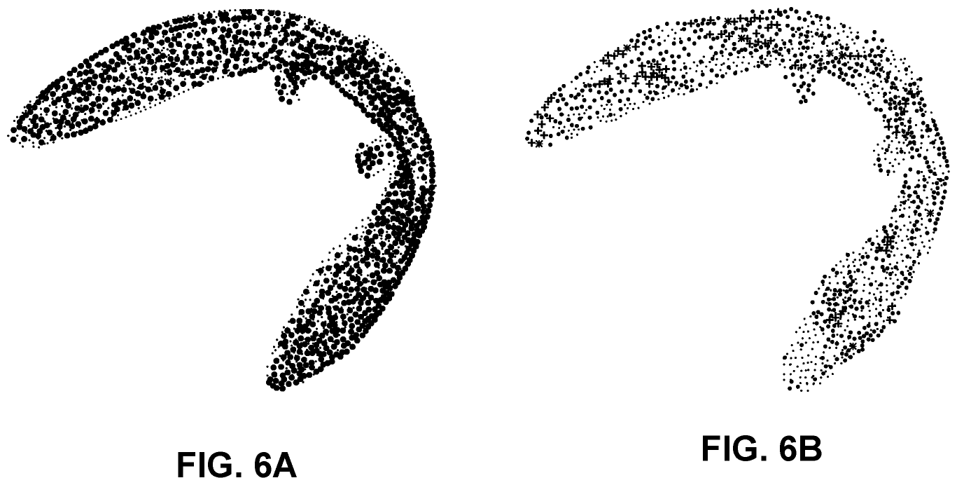

FIG. 6A is a diagram illustrating an example of a point cloud of a 3D object model. For instance, a point cloud of a 3D object model may be utilized as an input point cloud in accordance with some of the techniques described herein. In some examples of 3D printing, the 3D object model (e.g., CAD design) may provide data and/or instructions for the object(s) to print. In some examples, an apparatus may slice layers from the 3D object model. The layers may provide the data and/or instructions for actual printing. To enable printing with reduced deformation, the 3D object model may be controlled. The point cloud(s) of the 3D object model may provide the representation of the 3D object model, which may be utilized as machine learning model input. To measure and represent the shape (e.g., geometry) of manufactured objects, a 3D scanner may be utilized to measure the geometry of the actual printed objects. The measured shape may be represented as point clouds. The scanned points may be aligned with the points corresponding to the 3D object model, which may enable calculating the deformation. For example, with two datasets: (1) point clouds of the 3D object model(s) and (2) point clouds of the actual scanned object, a machine learning model or models may be developed to provide accurate manufactured object geometry prediction. The number and/or density of the point clouds utilized may be tunable (e.g., experimentally tunable).

FIG. 6B is a diagram illustrating an example of a predicted point cloud. For instance, the predicted point cloud of FIG. 6B may indicate object deformation and be predicted in accordance with some of the techniques described herein. In FIG. 6B, crosses indicate an amount of deformation and stars indicate a greater amount of deformation. In an experiment, overall mean squared error between scanned points and predicted point was 0.23 in the x dimension, 0.26 in the y dimension, and 0.32 in the z dimension.

Some examples of the techniques described herein may utilize a DGCNN and/or may adopt a KNN approach to accomplish edge convolution. Edge convolution may transfer feature extraction in an unstructured point cloud into regular convolution, which may enable local feature learning (e.g., for simulating detailed thermal diffusive effects). In some examples, global features (that simulate the overall thermal mass, for instance) may be implemented via incorporating the entire list of global coordinates of point clouds. Some examples of the techniques described herein may be beneficial by providing a data-driven end-to-end approach for geometry deformation prediction. Some examples of the techniques described herein may be beneficial by providing a deep learning approach that can learn local geometrical structures from unstructured cloud points, and can learn both local and global features that are consistent with physical insight.

Some examples of the techniques disclosed herein may be beneficial by providing a quantitative model(s) to predict surface geometry of a manufactured (e.g., printed) object and/or deformation ubiquitously (e.g., over an entire 3D object model) with improved speed and/or accuracy. Some examples may be beneficial by providing deep learning end-to-end models that may learn local and global features from point clouds, which may represent thermal fusion-driven deformation.

While various examples of systems and methods are described herein, the systems and methods are not limited to the examples. Variations of the examples described herein may be implemented within the scope of the disclosure. For example, operations, functions, aspects, or elements of the examples described herein may be omitted or combined.

1. A method, comprising:
predicting a point cloud that indicates a predicted object deformation using a machine learning model and edges determined from an input point cloud.

2. The method of claim 1, further comprising determining the edges from the input point cloud by determining neighbor points for each point of the input point cloud.

3. The method of claim 1, further comprising determining a local value for each of the edges.

4. The method of claim 3, further comprising determining a combination of the local value and a global value for each of the edges.

5. The method of claim 4, wherein the local value indicates local neighborhood information to simulate a thermal diffusion effect and the global value indicates global information to simulate a global thermal mass effect.

6. The method of claim 4, further comprising determining an edge feature based on the combination for each of the edges.

7. The method of claim 6, wherein predicting the point cloud comprises convolving the edge features to predict the point cloud.

8. The method of claim 1, wherein the machine learning model is trained with first point clouds from three-dimensional (3D) object models and second point clouds from scanned objects.

9. The method of claim 1, wherein the machine learning model comprises edge convolution layers.

10. The method of claim 1, wherein the predicted object deformation is based on thermal diffusion in three-dimensional (3D) printing.

11. An apparatus, comprising:
a memory;
a processor in electronic communication with the memory, wherein the
processor is to:
generate a graph by determining edges for each point of an input point cloud;
determine an edge feature for each of the edges of the graph; and
predict, based on the edge features, an object deformation resulting from three-dimensional (3D) printing of an object model, wherein the predicted object deformation is indicated by a point cloud.

12. The apparatus of claim 11, wherein the processor is to predict the object deformation using a machine learning model that comprises layers to convolve the edge features.

13. The apparatus of claim 12, wherein the processor is to determine the input point cloud from a 3D object model.

14. A non-transitory tangible computer-readable medium storing executable code, comprising:
code to cause a processor to convert an input point cloud into a graph based on determining neighbor points for each point of the input point cloud; and
code to cause the processor to use a machine learning model to predict, based on the graph, three-dimensional (3D) printing object deformation as a point cloud.

15. The computer-readable medium of claim 14, wherein determining the neighbor points comprises determining a set of nearest neighbor points relative to a point of the input point cloud, wherein the input point cloud corresponds to a 3D object model for 3D printing.
